(19) United States
(12) Patent Application Publication
(10) Pub. No.: US 2009/0282049 A1
(43) Pub. Date: Nov. 12, 2009

(54) MULTI-PARTNER CUSTOMS BROKING

(76) Inventor: Anthony Lane SNYDER, Fairfield, CA (US)

Correspondence Address: TRIMBLE NAVIGATION LIMITED C/O WAGNER BLECHER, 123 WESTRIDGE DRIVE, WATSONVILLE, CA, 95076, US

(21) Appl. No.: 12/119,149

(22) Filed: May 12, 2008

(51) Int. Cl. G06F 17/30; G06Q 30/00; G06F 15/16

(52) U.S. Cl. 707/10; 705/1; 709/203; 707/E17.032

(57) ABSTRACT

Systems and methods for customs broking are discussed. The computer implemented method comprises receiving a first data group from a first user, determining a second data group based on the first data group, the second data group configured to identify data elements, receiving at least some of the data elements from the first user, receiving a third data group from a second user, and based on the reception of data elements received from the first user, receiving data elements from the second user. The first data group comprises information for defining a transaction of one or more goods. The data elements are used for a customs classification of the one or more goods. The third data group comprising information for further defining the transaction of the one or more goods.

### TECHNICAL FIELD

Embodiments of the present technology relate generally to the field of customs broking.

### BACKGROUND

A transaction for goods that has a customs barrier may have many sources of information and involve many users. The transaction may start with an importer submitting a purchase order to a manufacturer or a foreign supplier. Then the manufacturer/supplier generates an invoice. Then a shipper and/or carrier generates a manifest and bills of ladings. Then, a customs broker/importer generates customs documents including an entry document and an entry summary. Then customs releases the goods. Then the customs broker/importer finalizes the entry summary. Then customs liquidates and/or alters the entry summary. Then the broker/importer may protest the liquidation/alteration. There are various exceptions, consolidations, and/or substitutions to this transaction process. For example, the customs house broker may input data that was missing from the other parties.

The customs house broker also determines one or more customs classifications for the goods and processes the order. The customs house broker determines the classification from information initially supplied by one or more of the trade partners and additional information requested from one or more trade partners. After the goods have been classified, a classification number is associated with the classification. The classification number may then be used to determine additional data/information to process the order and clear the goods through customs. The additional data may be determined by referencing customs regulations, procedures, and codes. Another function of the customs house broker is to collect the additional data. As well as custom number determination, the additional data may be used for additional reporting requirements and additional duty computational requirements and exemptions.

Classification determination may be an iterative process requiring the customs house broker to collect data multiple times from the same source via email and/or phone calls. For example, the customs house broker may request and collect some data, and then based on the collected data request more data. For some transactions, the custom house broker may need to collect additional data from the importer, manufacturer/supplier, shipper, carrier, and/or freight forwarder. Additionally, the customs house broker may need to verify and validate inconsistent and/or outdated information. This may take several days to complete. What is needed is a more efficient and effective way for customs broking and record keeping.

### SUMMARY

Systems and methods for customs broking are discussed herein. The computer implemented method comprises receiving a first data group from a first user, determining a second data group based on the first data group, the second data group configured to identify data elements, receiving at least some of the data elements from the first user, receiving a third data group from a second user, and based on the reception of data elements received from the first user, receiving data elements from the second user. The first data group comprises information for defining a transaction of one or more goods. The data elements are used for a customs classification of the one or more goods. The third data group comprising information for further defining the transaction of the one or more goods.

### BRIEF DESCRIPTION OF THE DRAWINGS

The accompanying drawings, which are incorporated in and form a part of this specification, illustrate embodiments of the presented technology for frictional heat assisted recording and, together with the description, serve to explain the principles of the presented technology:

FIG. 1 illustrates a customs broking system upon which embodiments of the present invention may be implemented.

FIG. 2 illustrates a server for customs broking, in accordance with embodiments.

FIG. 3 illustrates a screen view for data element entry for an invoice, in accordance with embodiments.

FIG. 4 illustrates a screen view for data element entry for an invoice with additional data elements based on a validation, in accordance with embodiments.

FIG. 5A (PRIOR ART) illustrates a flow diagram of data channeling between different users for customs broking.

FIG. 5B illustrates a flow diagram of data channeling between different users for customs broking, in accordance with embodiments.

FIG. 6 illustrates a flow diagram for entering data by multiple users, in accordance with embodiments.

FIG. 7 is a flow chart of a method for customs broking, in accordance with embodiments.

### DESCRIPTION OF EMBODIMENTS

In the following description, numerous specific details are set forth in order to provide a thorough understanding. However, it will be recognized by one of ordinary skill in the art that embodiments may be practiced without these specific details. In other instances, well known methods, procedures, and components have not been described in detail as not to unnecessarily obscure aspects of the present invention.

A system and method is configured to capture data elements for customs broking of one or more goods. The data elements are captured from several sources. The system and method also validates the data elements, determines additional data elements used for a classification of one or more goods, and processes the customs broking of the one or more goods.

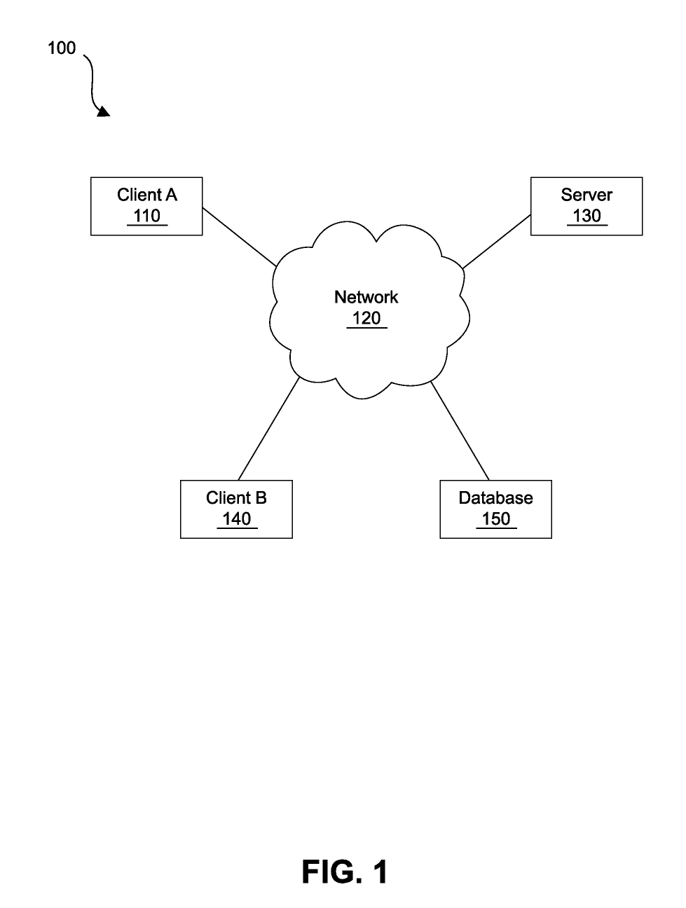

FIG. 1 illustrates a customs broking system 100 upon which embodiments of the present invention may be implemented. As illustrated, the customs broking system 100 comprises a client A 110, a network 120, a server 130, a client B 140, and a database 150. The client A 110 and the client B 140 are configured to communicate with the server 130 via the network 120. The server 130 is configured to communicate with the database 150 via the network 120. The network 120 may be any network to communicate digital data, such as an Internet, a local area network, a wide area network, a wireless network, or a telecommunications network.

The clients A 110 and B 140 may be used by users that may input and/or view customs broking data, such as an importer, a manufacturer/supplier, a shipper, a carrier, a customs broker, a consignee, a freight forwarder, any other trade partner, a law enforcement officer, and/or a customs officer. In some embodiments, there are clients similar to clients A 110 and B 140 for each user. The clients A 110 and B 140 may be viewed on a display coupled to a computer, a personal digital assistant, a mobile phone, or any other device that is adaptable to communicate via a network.

The network 120 may be an Internet, a telecommunication network, a computer network, or any network that may establish communications between client A 110 and server 130.

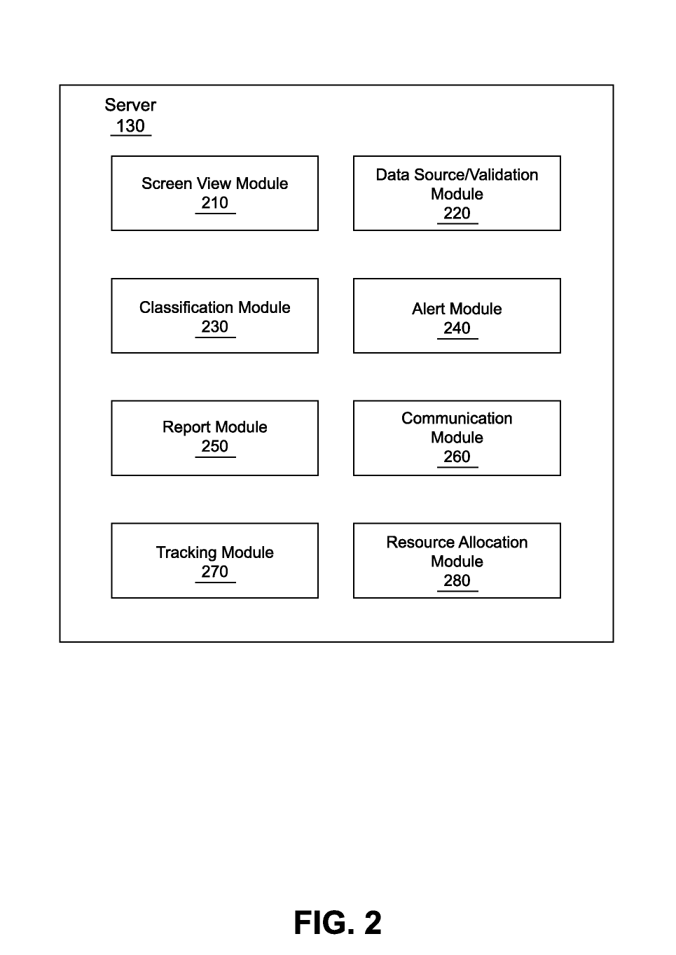

The server 130 may be one or more computers that communicate with client A 110, client B 140, and database 150. The server 130 will be discussed further herein and with regard to FIG. 2.

The database 150 is used to store data received from users. In some embodiments, the database 150 resides on the server. In various embodiments, the database 150 represents several databases only by private industries and government agencies. Some government agencies may include databases used by the United States Customs and Border Protection.

FIG. 2 illustrates a server for customs broking, in accordance with embodiments. As illustrated the server 130 comprises a screen view module 210, a data source/validation module 220, a classification module 230, an alert module 240, a report module 250, a communication module 260, a tracking module 270, and a resource allocation module 280.

The data screen view module 210 is configured to display data elements and data element fields to users. In various embodiments, the data screen view module 210 determines a category of the user and displays relevant data elements and/or fields. The display may be unique for different users. In some embodiments, the data screen view module 210 takes into consideration a user preferred interface and/or database, such as a standard query language interface, an application program interface, a custom interface, and/or a third-party database interface.

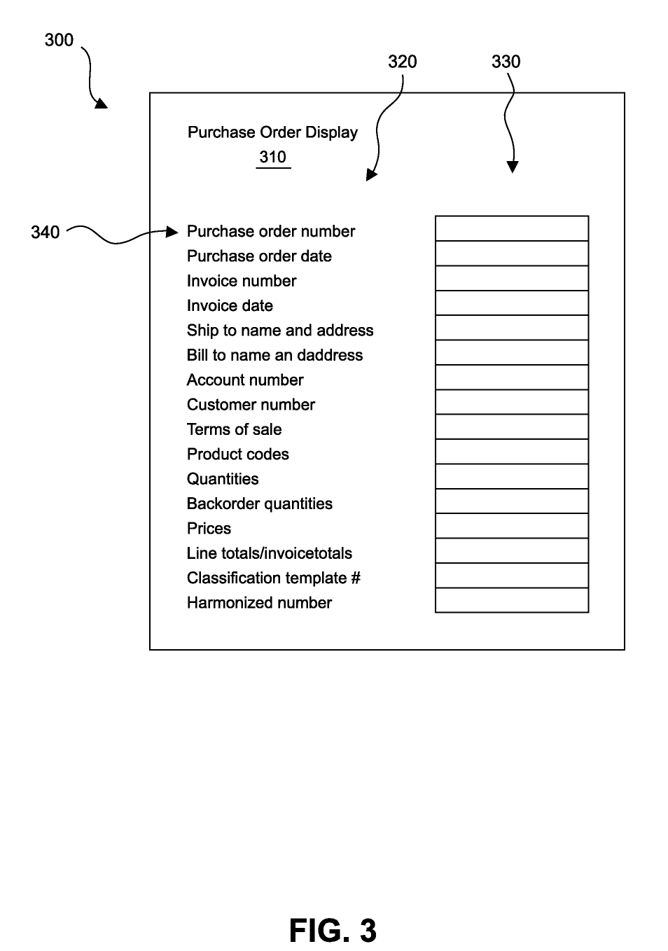

In various embodiments, the data screen view module 210 takes into consideration a screen size of the user and proportions a display tailored for the screen size. For example, if a user is using a personal digital assistance, scroll bars may be used to navigate though the data elements and/or segments of data elements, effectively allowing a user to view all the data elements. An example display is discussed in FIG. 3 and herein.

The data source/validation module 220 auto-populates data elements, validates data, and prompts users for additional data elements. The data source/validation module 220 receives and validates data from some or all data sources associated with the brokerage of goods, such as users entering information regarding an invoice, bills of ladings, a manifest, an entry document, and an entry summary. Data may be entered line-item-by-line-item, as a batch process, or as individual data elements.

### Data Elements

Data elements may be populated by users and/or automatically populated. In various embodiments, some data elements may be field elements. In other embodiments, all the data elements are field elements. Field elements are identifications using a naming system, such as the Customs and Trade Automated Interface Requirements. A field name may be descriptive of the field element. For example, a field name, “ImporterID” may have a field element ALMAFOODSLTD, which is descriptive for Alma Foods, LTD. Some example field names (and corresponding field elements) are Importer of Record (a 12 character multi-format number, typically the IRS number), Consignee (the same 12 character multi-format number), District (a first two digits of a port code), Port (a second two digits of the port code), and Entry Number (an 8-14 digit field depending partially on paperwork prepared by a broker for an importation of goods). In various embodiments, some field elements do not resolve to simple names, for example, addresses may resolve into one or more identification systems. In another example, a manufacturer identification may be derived from the full company name and address as printed on an invoice, and through an algorithm converts to the field element as a fifteen character code. In some embodiments, a data element may be obtained by concatenating two or more field elements. For example, to get a unique application number, an application identification, a record number, and a position within a record are combined.

### Auto-Population of Data Elements

The data source/validation module 220 may automatically populate data elements. Data elements that may be automatically populated are computed figures, plus data that may carry over from previous inputs into other applications, such as the data from an entry may carry over to an entry summary. Other automatically populated data elements include data from address tables that may carry over to entries and entry summaries, data from a manifest and a manufacturer invoice may carry over to entries and entry summaries, and various meta data tables such as those used in the classification module 230 may carry forward to help classify an entry and entry summary.

Additionally, automatically populated data elements include various customer specific templates that may help to automate transaction elements specific to a customer which may include certifications, permits and licenses on file for the customer, default terms of sale for the merchandise being imported, negotiated billing terms for billing the customer for a customs broker's work, and pre-selected classification template codes that the customs broker may have determined to match goods that a customer sells. The pre-selected classification template codes may be used in conjunction with algorithms stored in the templates to automate a classification process for an individual transaction. Yet other automatically populated data elements may include a final classification.

Traditionally, some data elements, such as freight were not determined until a customs broker had most or all the information necessary to customs-broker the goods. Freight is a term used to classify a transportation of goods. The freight classification may depend on several factors, such as, a type of goods, a size of the goods, a weight of the goods, a duration for the transportation of the goods, a special handling of the goods, a cost of the transportation of the goods, and the like.

In various embodiments, the data source/validation module 220 may determine the freight automatically after receiving and/or validating a manifest without having the customs broker input any data elements. In other embodiments, information from a carrier is used to automatically determine the freight. In some embodiments, a standard and/or generic freight is used to obtain an estimated freight, whereby the freight may later be adjusted by one or more users. In still further embodiments, agreements between users may be used that would allow for automatic determination of data elements, such as freight, without additional user interaction. Some specific data elements, such as dates and/or certifications may be entered and/or modified at a later time.

### Validation

The data source/validation module 220 may validate data at each and every stage as the data is received. The data may be analyzed and validated in real-time. In various embodiments, the data source/validation module 220 validates data elements as a source-data validation approach. The source-data validation approach reviews each source of data as a group of data and determines other data elements that may be used by the classification module 230, discussed further herein, to determine a classification of the goods. The source-data validation approach also reviews the completeness of data at a source by source basis.

### Prompting Users for Additional Data Elements

The data source/validation module 220 may determine the additional elements used for classification in real-time. The user is prompted with the additional data elements, where appropriate, while the user is engaged with inputting data elements. For example, after a user enters rice as the goods, the data source/validation module 220 prompts the user for harvest information. An engagement may be one session by a user as the user is inputting and/or supplying, and/or inputting, supplying, and/or responding to additional elements. In some embodiments, a user may optionally engage with the server 130 as many times as the user desires.

In various embodiments, the additional data prompts may be color-coded to identify if a particular user or another user may enter the data. For example, a data element name and/or field may be populated in red, yellow and/or other attention-alerting way, so as to alert and/or notify the user that one or more data elements are requested. In various embodiments, the user may not be able to complete a transaction without supplying necessary data elements, the necessary data elements being identified in red. In other embodiments, additional necessary data elements may be supplied by other users, and these data elements may be identified in yellow, indicated that they are necessary for the transaction, but may also be supplied by others who may be better knowledgeable of the necessary information. In some embodiments, a last user, such as a freight forwarder, may supply any remaining red and/or yellow data elements, so as to complete a data entry for a transaction.

In other embodiments in which a user enters data elements as a set, determination of necessary data elements are determined after a user submits the set of data. In still further embodiments, data elements may be entered one at a time and/or as a set. In various embodiments, the necessary data elements may be requested individually and/or as a data group of data elements. For example, if a user supplies an original set of data elements, then the data source/validation module 220 may request a several additional data elements related to one or more different original data elements.

The data source/validation module 220 may determine and request necessary data elements within seconds after receiving data and/or may prompt the user with additional data elements within several seconds from the time the user sends data. A delay may be dependent on computer processing speed and/or Internet latency.

In some embodiments, the server 130 is configured to accept data from different client software interfaces, such as custom design clients, API, etc. In other embodiments, error codes and/or messages are used to notify a user that additional data elements are necessary. The error codes and/or messages may be used to alert a user using an application program interface.

In various embodiments with a user using an application program interface, validation rules may be applied to the transaction as a whole, immediately rejecting a transaction with error codes that interpret into the fields that were required. The user would then need to enter necessary and/or required data, and/or automate part of the process with custom software. In other embodiments with a user using an application program interface, a user may query rules in advance so as to create fields and/or routines to enter data elements without receiving error codes. In various embodiments, users may tailor software to meet specific needs and/or preferences.

### Cross Application Validation

In some embodiments, the data source/validation module 220 cross application validates the data, for each line item as the line item is entered. Cross application validation facilitates data entry and/or data portal for input of a manufacturer invoice and/or importer purchase order, while simultaneously and transparently siphoning data through the classification module 230. Typically, the input of a manufacturer invoice and/or importer purchase order starts the process. The classification module 230 attempts to classify the goods while the user is engaged, and in the case of incompleteness, the data source/validation module 220 requests additional data and/or data validation rules to be used to complete the classification on a subsequent attempt by the same user during the same engagement or by another user in a different engagement.

In some embodiments, the user may be required to input the additional data, whereby the additional data may be subject to additional validation via the source/validation module 220. The process may be repeated several times for one set of goods, and repeated again for each additional set of goods. In various embodiments, the process may be completed when the invoice contains sufficient data to fully and automatically generate the one or more customs classification numbers. There may be one or more customs classification numbers associated with the same set of goods.

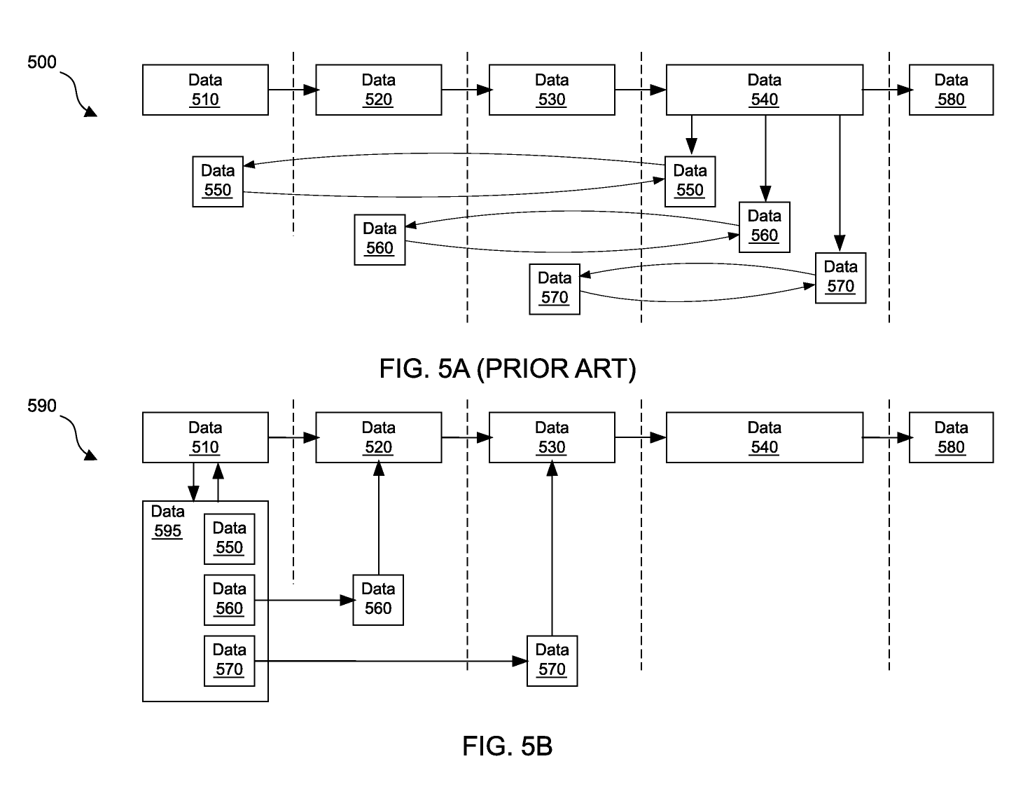

In other embodiments, the process may be completed when necessary data is identified, some of the data which may be completed by other users, such as a shipper. In various embodiments, the data source/validation module 220 collects data from each source as an entirety; thereby each source (or user) is inconvenienced with one engagement, thus eliminated follow-up phone calls, faxes and so on to get the missing data. Cross application validation is further discussed herein and in FIG. 5B.

The classification module 230 classifies in real-time as a manufacturer or other user supplies data elements in an invoice. The classification module 230 coordinates with the data source/validation module 220 to obtain the data elements used to determine the classification. In various embodiments, the classification module 230 may determine a classification based on the purchase order, the invoice, and/or the additional data elements prompted by the data source/validation module 220. In various embodiments, the classification module 230 transparently classifies as the user is engaged.

In another embodiment, the server 130 may determine one or more classifications for each of the one or more goods with only using information supplied by the manufacturer/supplier while the manufacture/supplier is engaged with the server for one session. Other data elements may be identified to be supplied by other users to be used for customs broking, but these other data elements are not used in the classification of the goods.

In some embodiments in which multiple users enter data for the classification determination, the server 130 determines and collects sufficient data from each user so that each user has one engagement. In this situation, the classification module 230 may determine that a classification using just the invoice is not necessary as the classification module has identified data necessary for classification, and has determined that the necessary data may be collected by one or more subsequent users. For example, after the manufacturer has entered invoice information and supplied additional information requested by the data source/validation module 220, the classification module 230 still has not completed the classification, but has determined that with a few more data elements, that are commonly supplied by a shipper, a classification may be made.

The classification is a rule based process and uses fields extracted from the “broker classify process” as spelled out within all the rulings and supplemental pages of the US Harmonized Tariff and Census Guide.

As users need only one engagement with the server 130, the users save time and the transaction may be more efficient than if a customs broker needs to collect additional data for a classification of the goods.

The alert module 240 may identify heightened risks or situations, potential customs violations, and/or current affairs. Some potential alerts may include entries approaching due dates, Temporary Import Bonds approaching due dates, protests changing status, protests approaching expiration, and for broker-customer certifications approaching expiration. Some current affairs may include reports of embargoes, wars, and/or natural disasters, such as typhoons. In some embodiments, the alert module 240 may determine and notify a user if a Generalized System of Preferences is applicable and/or assists with short notice changes to antidumping, by obtaining an antidumping case number and determining if the case number is applicable to the clearance of the one or more goods.

The report module 250 may generate paperwork for each of the users with minimal effort, at the request of a user, off-line, and/or with little to no data entry. The report module 250 may help with the clearance of the goods by sending data, files, and/or reports to appropriate users and/or customs departments.

The communication module 260 may assist with communication. Communications may digital-to-digital or analog-to-digital. Analog-to-digital communication may be performed with the use of voice recognition software and/or text digitizing software.

The tracking module 270 may track entry and/or liquidation status of the goods. In some embodiments, a user may use the tracking module 270 to display a location and a time of arrival of the goods.

The resource allocation module 280 may assist with accounting and/or invoicing. In some embodiments, the resource allocation module 280 automatically invoices accounting departments. As the resource allocation module 280 resides on the server 130, invoice data is readily and easily populated. In some embodiments, the resource allocation module 280 computes taxes, duties, excises, fees, non-dutiable charges, and/or other monetary transactions. In various embodiments, the resource allocation module 280 remunerates, transfers funds and/or pays taxes, duties, excises, fees, and/or other monetary transactions between users, designated non-users, and/or customs.

FIG. 3 illustrates a screen view 300 for data element entry for an invoice, in accordance with embodiments. The screen view 300 comprises an invoice view 310. The invoice view 310 comprises various data element names 320, such as a purchase order number 340, and data element entry boxes 330. Typically a manufacturer and/or supplier may input data for the data element entry boxes 330. Some other common data elements for the invoice view 310 may include a purchase order date, an invoice number, an invoice date, a ship to name and address, a bill to name and address, an account or customer number, terms of sale, product codes, quantities, backorder quantities, prices, line totals, and/or an invoice total. In some embodiments, the invoice screen view includes a classification template number and/or a harmonized number. The harmonized number may be different for each detail line.

A custom set of user screens and/or application program interfaces may be generated by the screen view module 210 for each user and/or each type of user. Each user may have a different screen view with some similar and/or different data elements. For example, an importer screen (not depicted) may have the purchase order number, purchase order date, product codes, quantities, shipping and billing information in common with an invoice screen, but may also have additional data elements, such as, a contact person name and phone, discount codes, and notes. In some embodiments, a screen view may contain links (not depicted) to navigate between screens to address similar multiple data elements. For example, multiple goods having different discount codes.

In various embodiments, screen views may be multi-layered to accommodate a display of information in an ordered way. For example, bills of ladings which identify the individual shipping orders, to ship a list of cargo from one point to another, may be collected onto a manifest. The manifests are regrouped onto entries which are potentially one-to-many, many-to-one, and/or many-to-many. The manifests may be displayed in a fashion to represent a larger picture view with links to the each of potentially many routes, many bills of ladings, and/or many goods.

In another example of having customized screen views, a customs broker screen view may contain some and/or all the data elements related to the transaction, and in addition may contain an importer number, consignee numbers and addresses, miscellaneous license numbers and permit numbers, various data elements for Federal Drug Agency, Department of Transportation, and additional Other Government Agencies, bill of lading numbers, inbound numbers, international trade numbers and dates, surety code, freight information, miscellaneous documents, miscellaneous flags/indicators, location codes, and computed values, such as duties, taxes, fees, non-dutiable charges, entered values minus non-dutiable charges, and totals.

Quantities may show units of measure. Prices and totals may be in a foreign currency, and as applicable include a conversion to United States currency. An International Organization for Standardization country code is used for the country of the currency, and a currency code is used to designate a foreign currency type. Both codes may be used to determine a currency conversion, which may be queried from customs for a specific effective date that may depend on the terms and date of the sale.

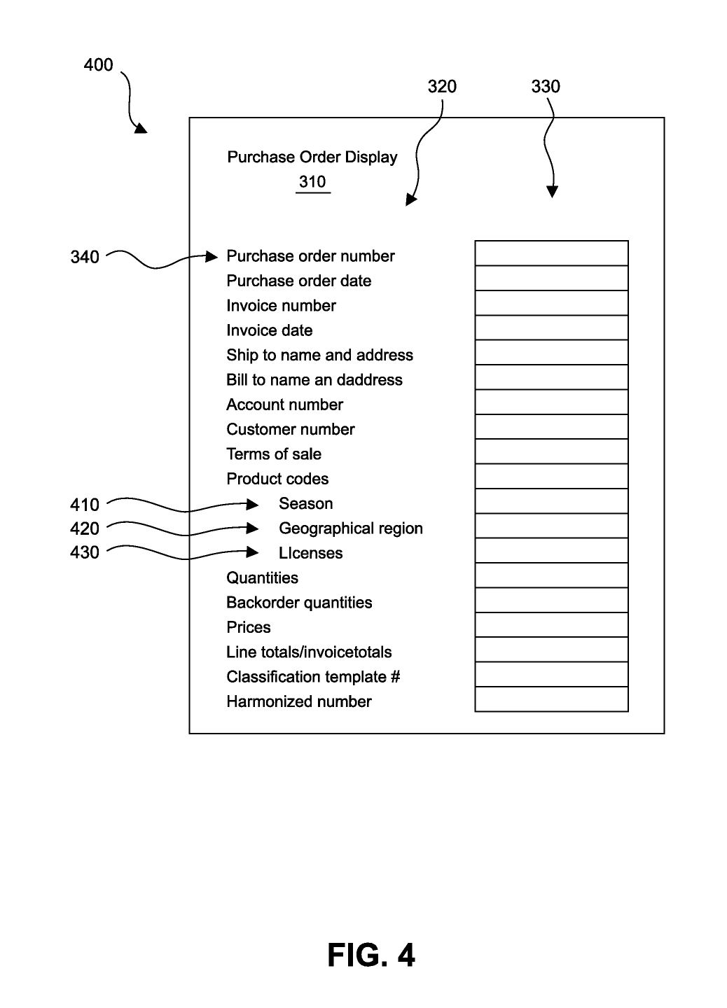

FIG. 4 illustrates a screen view 400 for data element entry for an invoice with additional data elements based on a validation, in accordance with embodiments. Screen view 400 is similar to screen view 300 except for additional data elements comprising season 410, geographical region 420, and licenses 430. The additional data elements may be populated after a user has entered some data elements and a validation of one or more data elements by the data source/validation module 220 generated a request for more data elements. The additional data elements may be used for a classification number determination, or for other customs broking processes, such as a clarification for an entry date falling on a non-standard work day.

The season data element 410 may be requested if goods are perishable. The geographical region data element 420 may be requested if the goods from a particular country are under quarantine surveillance and more details are needed to distinguish the goods. The licenses data element 430 may be requested if suppliers are regulated. In other embodiments, there may be a plethora of additional data elements in response to user supplied data elements for data elements listed on an original screen and/or data elements populated by the data source/validation module 220. For example, assume A, B, C and D are data elements, a user supplies A, then B is populated by the data source/validation module 220, the user supplies B, and then C and D are populated.

FIG. 5A (PRIOR ART) illustrates a flow diagram 500 of data channeling between different users for customs broking. The data flow diagram 500 comprises data 510-580, arrows to indicate flow paths, and dotted lines to separate different sources of data. Data 510-540 and 580 may represent typical data used to complete a transaction. Data 550-570 may represent typical data used to generate a custom classification number, clear a customs process, and/or specific data used to complete a transaction. The flow diagram starts with data 510 being submitted on a document, such as a purchase order and/or an invoice. The data 510 is reviewed and another document is generated, such as bills of ladings, containing data 520. Next data 520 is reviewed and another document is generated, such as a manifest, containing data 530. Then a customs house broker reviews data 510-530, generates some data 540, and requests data 550 from the user who supplied data 510. After the customs house broker receives data 550, a classification is determined. Then the customs house broker requests data 560-570 from users who supplied data 520-530, respectively. Alternatively, the customs house broker may be able to have enough information to request data 560 and/or data 570 simultaneously with the request for data 550. Alternatively, data 550-570 may be supplied by one or more users who supplied data 510-530. Alternatively, any of data 550-570, may be requested as an iterative process, as discussed herein, while the customs house broker is determining the classification number. After all the data 550-570 is collected, the customs house broker generates more documents and/or data 540 and the process continues to a consignee and/or to customs where data 580 may be generated.

FIG. 5B illustrates a flow diagram 590 of data channeling between different users for customs broking, in accordance with embodiments. The flow diagram 590 and flow diagram 500 are similar for most of the data 510-580 are similar. The flow diagram 590 is different, however, at least in a way of the data 550-570 determination and flow of data between the users. Another difference is that, the data source/validation module 220 and/or classification module 230 determines and requests data 550-570, as indicated by data 595.

In some embodiments, the data 550-570 is determined by the data source/validation module 220 at the time the user who supplies data 510 inputs data 510. The user who supplies data 510 may then seamlessly supply data 550 while still engaged. Similarly, data 560-570 may be collected by users who supplied data 520-530, respectively, while engaged. In other embodiments, the data 550-570 may be determined by the data source/validation module 220 at any time prior to any of the users who supplies data 510-530 completes the engagement. For example, data 570 may be determined while a user is inputting data 520. In various embodiments, data 595 privy to the users who supply data 510-530, may be supplied by any of these users. For example, the user who supplies data 520 also inputs some or all of data 550-570.

In some embodiments, data 580 is generated, optionally, by a consignee. Data 580 may be an acknowledgement. Then customs releases the goods. Then the customs broker/importer finalizes the entry summary. Then customs liquidates and/or alters the entry summary. Then the broker/importer may protest the liquidation/alteration. There are various exceptions, consolidations, and/or substitutions to this transaction process. For example, a freight forwarder may supply some or all of the information for the manifest.

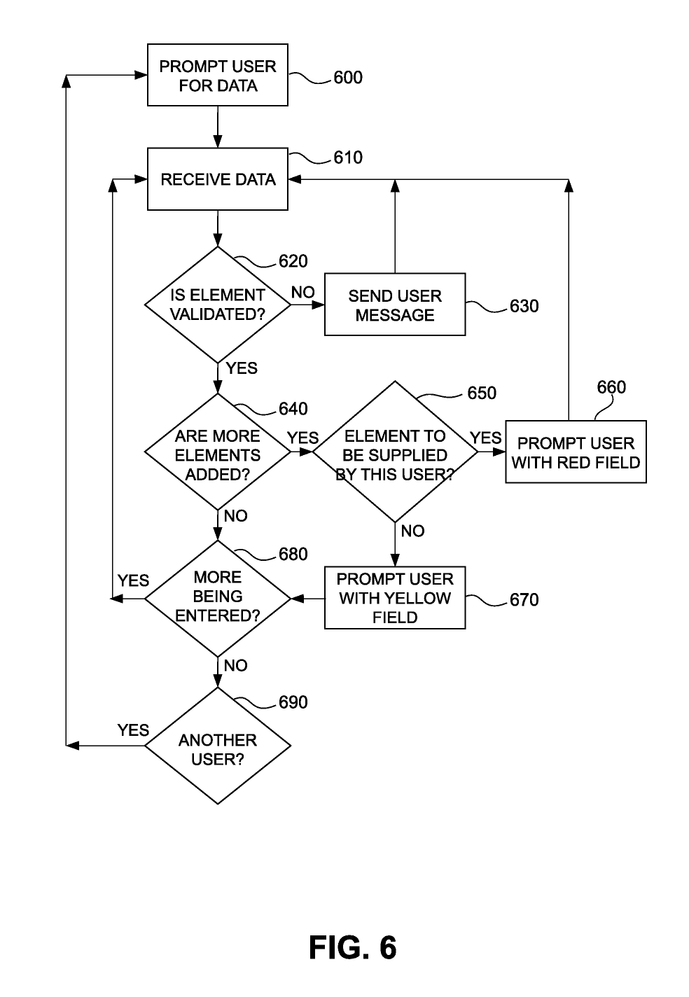

FIG. 6 illustrates a flow diagram for entering data by multiple users, in accordance with embodiments. There are many people involved for a transaction for goods that has a customs barrier and data compilation may be complex. Typically, the first user to enter data is an importer who is submitting a purchase order. Occasionally, the importer may not enter data, may not have access to a device for which data may be entered, or may have another user enter invoice data. In some embodiments, all the information that would have been supplied on an invoice is supplied via a purchase order. At box 600, a user, such as an importer, is prompted for data. For example, if an user/importer would like to procure toothpaste, then the importer would be prompted with data elements such as quantity, tube size, desired delivery date, and the like. At box 610, the data is received.

At box 620, the data source/validation module 220 validates the data element by element and/or by groups of elements. In various embodiments, if the data is not validated, perhaps due to a formatting error and/or there is a problem with the data, at box 630, a message is sent to the user assisting the user with a better way to enter the data. For example, if a user enters a number where a letter was expected, a message may be sent to the user indicated a proper syntax. In another example, if a user/importer enters data indicating a request to order toothpaste from Madagascar, then a message may be sent suggesting that there is no toothpaste manufacturer in Madagascar.

If the data is validated, the data source/validation module 220 determines if there are additional data elements at box 640. If there are additional data elements, the data source/validation module 220 determines if the additional data elements are to be supplied by the user currently entering data or by a subsequent user. If the additional data element or elements are to be supplied by the current user, then at box 660, the user is prompted with a red field to supply the additional data element or elements. If the additional data element or elements are to be supplied by a subsequent user, then at box 670, the current user is prompted with a yellow field to supply the additional data element or elements. For example, if an importer enters a data field for a quantity of toothpaste to order as 100,000 units, then another field may be prompted with a yellow field requesting if multiple containers are permitted over multiple shipments, or if the entire shipment is be in one container. If this user is impartial as to a mode of transport, the user may opt to leave this field blank as the data will be supplied by a subsequent user. In various embodiments, the color and/or another attention method is used, as discussed herein.

If there were not more elements added by the data source/validation module 220 at box 640, then the data source/validation module 220 determines if more data is being or should be entered at box 680. If more data should be entered and/or is being entered, the process continues until all data is received. If no more data is being entered and/or no more should be entered by this user, the data source/validation module 220 determines if there is another subsequent user at box 690 to enter any unsupplied data. The process many continue until all data has been supplied. Typically, each of the users will supply some data. Thereby, the importer will supply purchase order data, the manufacturer/supplier will supply invoice data, a shipper and/or carrier will supply bills of lading data, and the like. In various embodiments, data may be modified and/or updated by user with appropriate permissions.

To continue the toothpaste example, after the importer supplies all the data prompted by the data source/validation module 220, except for the optional yellow field prompted data, then a manufacturer supplies data such as documents for Occupational Safety and Health Administration compliance, such as a chemical composition of the toothpaste, delivery scheduling, delivery details, and the like. After the manufacturer supplies data, the shipper supplies data regarding ports, transport scheduling, container specifics, and the like. After the shipper supplies data, the customs broker generates and/or verifies an entry document and an entry summary. Then after customs releases the goods, the customs broker/importer finalizes the entry summary. Then customs liquidates and/or alters the entry summary. Then the broker/importer may protest the liquidation/alteration. For example, if customs purports the shipment violated shipping lanes, then the broker produces records to contrary. In various embodiments, Customs Officers requests and/or accesses data supplied by the users to determine transaction diligence and/or expedite customs clearance.

In another example, an importer orders 1000 BMW's from a BMW factory Munich and submits data for the vehicles in the form of a purchase order. Then the BMW manufacturer supplies data regarding weight, sizes, availability, and the like in an invoice, and other data available and/or commonly known by the manufacturer. During the manufacturer's submission, the data source/validation module 220 may prompt the manufacturer with additional fields, in red and yellow. The red fields may include such items as terms of delivery, handling requirements, and the like which are better known by the manufacturing. The yellow fields may include shipping preferences, ports of debarkation, and the like which may be supplied by manufacturer or a shipper.

In various embodiments, a manufacturer may supply additional rules for to the data source/validation module 220, so an importer may select goods that have options. For example, a BMW manufacturer supplies rules for a product line of automobiles with current options, such as leather, colors, navigation systems, and other packages, so when an importer enters a purchase order, the cars may be ordered as if the importer was ordering from a local car dealer knowledgeable of the different options. The data source/validation module 220 may populate the options as the importer drilled down into the details of the order. For example, after the importer inputted a BMW M5 Sedan in a goods field, the data source/validation module 220 would prompt the importer with new fields listing specific options for the sedan. This may allow a manufacturer to update a product line just-in-time for an importer to submit data.

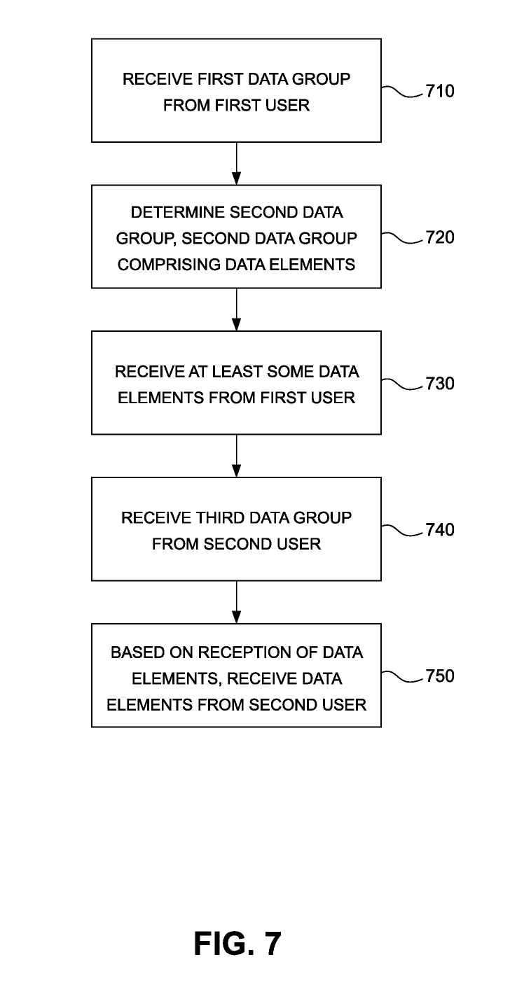

FIG. 7 is a flow chart of a method for customs broking, in accordance with embodiments. In step 710, a first data group is received from a user. The first data group comprises information for a transaction of one or more goods. The data group may contain purchase order and/or invoice information.

In step 720, a second data group is determined based on the first data group. The second data group is configured to identify data elements to be used for a customs classification of the one or more goods. In various embodiments, the data elements are determined in response to a user entering data for the purchase order and/or invoice. In other embodiments, the data elements are determined in response to any user and/or trade partner data entries for the transaction.

In step 730, at least some of the data elements are received from the user supplying the first data group.

In step 740, a third data group is received from another user. The third data group comprises additional information for the transaction. In various embodiments, the third data group comprises bills of ladings and/or manifest information.

In step 750, some data elements not yet received from the user supplying the first data group are received from the user supplying the third data group. In various embodiments, all necessary data to determine a classification number is received by a manufacturer/supplier and other necessary data to broker the goods are received from a shipper, freight forwarder, and/or carrier.

While the embodiments illustrated in steps 610-650 show specific sequences and quantity of steps, the present invention is suitable to alternative embodiments. For example, not all the steps provided for in the methods are required for the present invention. Furthermore, additional steps may be added to the steps presented in the present embodiment. Likewise, the sequences of steps can be modified depending upon the application.

Various alternatives, modifications, and equivalents may also be used. For example, the changes in quantities of the goods are made and the different classification numbers are generated automatically. Therefore, the above description should not be taken as limiting the scope of the invention which is defined by the appended claims.

While the invention is described in conjunction with various embodiments, it is understood that they are not intended to limit the invention to these embodiments. On the contrary, the invention is intended to cover alternatives, modifications and equivalents, which may be included within the spirit and scope of the invention as defined by the appended claims.

What is claimed is:

1. A computer implemented method for customs broking comprising:
receiving a first data group from a first user, the first data group comprising information for defining a transaction of one or more goods;
determining a second data group based on the first data group, the second data group configured to identify data elements to be used for a customs classification of the one or more goods;
receiving at least some of the data elements from the first user;
receiving a third data group from a second user, the third data group comprising information for further defining the transaction of the one or more goods; and
based on the reception of data elements received from the first user, receiving data elements from the second user.

2. The method of claim 1, wherein the first data group comprises a purchase order.

3. The method of claim 1, further comprising determining a fourth data group based on the third data group, the fourth data group configured to be supplied by the second user and to be used for the transaction of the one or more goods.

4. The method of claim 3, further receiving a fifth data group by a third user, determining a six data group based on the fifth data group, the six data group configured to be supplied by the third user and to be used for the transaction of the one or more goods.

5. The method of claim 1, wherein the first user is a manufacturer/supplier of the one or more goods.

6. The method of claim 1, further comprising determining a customs classification number for the one or more goods based on the first data group and the second data group, the customs classification number configured to be used to process a clearance of the one or more goods through a customs barrier.

7. The method of claim 6, wherein the data for the first data group and at least a part of the second data group are supplied by a manufacturer/supplier during one engagement.

8. The method of claim 1, further comprising auto-populating the third data group with data from a group consisting of a purchase order and an invoice.

9. The method of claim 1, further comprising customs clearing the one or more goods.

10. The method of claim 1, further comprising tracking the one or more goods.

11. The method of claim 1, further comprising determining if an alert is associated with the clearance of one or more goods.

12. The method of claim 1, further comprising obtaining an antidumping case number and determining if the case number is applicable to the clearance of the one or more goods.

13. The method of claim 1, wherein the processing further comprises determining a cost selected from a group consisting of taxes, duties, excises, fees, and entered values.

14. The method of claim 1, further comprising receiving by the second user at least some of the data elements used for the customs classification, and determining a customs classification number while engaged with the second user, the customs classification number configured to be used to process a clearance of the one or more goods through a customs barrier.

15. A computer implemented method for customs broking comprising:
receiving an invoice from a manufacturer/supplier, the invoice comprising information for defining a transaction of one or more goods;
determining a second data group based on the first data group, the second data group configured to identify data elements to be used for a customs classification of the one or more goods;
receiving at least some of the data elements from the manufacturer/supplier;
receiving a manifest from a carrier/freight forwarder, the manifest comprising information for further defining the transaction of one or more goods; and
based on the reception of data elements received from the manufacturer/supplier, receiving data elements from the carrier/freight forwarder.

16. The method of claim 15, further comprising determining a customs classification number for the one or more goods based on the first data group and the second data group, the customs classification number configured to be used to process a clearance of the one or more goods through a customs barrier.

17. A computer implemented method for customs broking comprising:
receiving a first data group comprising information for defining a transaction of one or more goods;
determining a second data group based on the first data group, the second data group configured to identify data elements to be used for a customs classification of the one or more goods;
receiving the second data group; and
determining a customs classification number for the one or more goods based on the first data group and the second data group, the customs classification number configured to be used to process a clearance of the one or more goods through a customs barrier.

18. The method of claim 17, wherein the first data group is received from a first user, and further comprising receiving a third data group from a second user, the third data group comprising information for further defining the transaction of the one or more goods.

19. The method of claim 17, wherein the first data group comprises an invoice.

20. The method of claim 17, wherein the first user is a manufacturer/supplier of the one or more goods.

21. A system for customs broking comprising:
a server configured
to receive a first data group from a first user, the first data group comprising information for defining a transaction of one or more goods,
to determine a second data group based on the first data group, the second data configured to identify data elements to be used for a customs classification of the one or more goods,
to receive at least some of the data elements from the first user,
to receive a third data group from a second user, the third data group comprising information for further defining the transaction of the one or more goods, and
based on the reception of data elements received from the first user, to receive data elements from the second user;
a first user interface configured to be used by the first; and
a second user interface configured to be used by the second user.

22. The system of claim 21, wherein the server is further configured to determine a customs classification number for the one or more goods based on the first data group and the second data group, the customs classification number configured to be used to process a clearance of the one or more goods through a customs barrier.

23. The system of claim 22, wherein the data for the first data group and at least a part of the second data group are supplied by a manufacturer/supplier during one engagement.

24. The system of claim 21, wherein the server is further configured to determine all the data elements necessary for a customs classification of the one or more goods while engaged with the first user, and to receive at least some of the data elements from a subsequent user.
